(19) United States
(12) Patent Application Publication
(10) Pub. No.: US 2013/0258110 A1
(43) Pub. Date: Oct. 3, 2013

(54) System and Method for Providing Security on Demand

(71) Applicant: Nicolas John DeMarco, Amityville, NY (US)

(72) Inventor: Nicolas John DeMarco, Amityville, NY (US)

(73) Assignee: Honeywell International Inc., Morristown, NJ (US)

(21) Appl. No.: 13/438,722

(22) Filed: Apr. 3, 2012

(51) Int. Cl. H04N 7/18; G08B 25/00; G08B 23/00

(52) U.S. Cl. 348/155; 340/517; 340/525; 348/152; 348/E07.085

(57) ABSTRACT

A method and system for providing security services. The method includes the steps of establishing a plurality of security applications for an individual person, each embodied as a set of program steps saved in a non-transitory computer readable medium accessible by a security system of the person and each incorporating a respective set of sensors at least some of which provide intrusion detection for a secure geographical area of the person, incorporating the plurality of security applications into a control interface of the person, the control interface receiving one or more control instructions from the person, the received control instructions associated with at least one of the plurality of security applications and the at least one security application providing the security feature to the person based upon the input of the respective set of sensors in accordance with the set of control instructions.

### FIELD

The field relates to security systems for homes and businesses and more particularly to methods and apparatus for controlling the scope of use of security systems.

### BACKGROUND

Security systems are generally known. Such systems typically involve the protection of a particular geographic area from known risks such as burglary, fire, etc.

Typically, a security system involves some sort of physical barrier (e.g., a fence, walls, etc.) around a secure area. One or more sensors (e.g., limit switches) may be located on portals (e.g., doors, windows, etc.) that allow entry into the secure area.

The sensors may be coupled to an alarm panel located within the secure area. The control panel may include circuitry that activates a local audible alarm upon activation of one of the sensors by an intruder.

Also associated with the alarm panel may be a user interface (e.g., a keyboard and display). Usually, the user interface is located proximate a main entry into the secure area. Locating the user interface proximate the main entry provides a convenient means to arm the system when the owner leaves and to disarm the alarm when the owner returns.

Control of the alarm system typically includes entry of an identifier (e.g., a personal identification number (PIN)), through the keyboard, plus entry of a function key (e.g., arm, disarm, etc.). Where the user interface is located inside the secure area, activation of the sensor on the main entry is associated with a time delay that allows an authorized person to access the user interface through the main entry and deactivate the alarm system before the audible alarm is activated.

While existing alarm systems work well, they are not very adaptable to changing alarm environments. Accordingly, a need exists for alarm systems that are more flexible.

### BRIEF DESCRIPTION OF THE DRAWING

FIG. 1 is a block diagram of an alarm system shown generally in accordance with an illustrated embodiment.

### DETAILED DESCRIPTION OF AN ILLUSTRATED EMBODIMENT

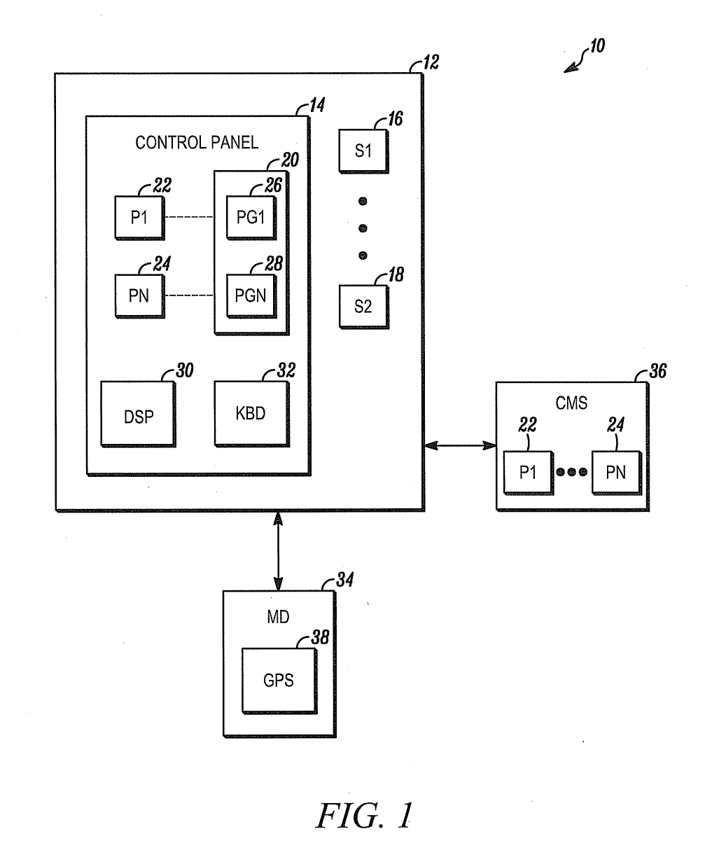

FIG. 1 depicts the alarm system 10 that protects a secure area 12 under one illustrated embodiment. Included within the alarm system 10 may be a main control panel 14 coupled to one or more sensors 16, 18. A user interface including a display 30 and keyboard 32 may, in turn, be coupled to the control panel 14.

The sensors 16, 18 may be based upon any appropriate technology. For example, the sensors 16, 18 may include one or more perimeter sensors disposed on portals (e.g., doors, windows, etc.) that provide entry into the secure area 12. Alternatively, the sensors 16, 18 may be motion detectors placed outside and/or inside the secure area. The sensors 16, 18 may also include television cameras located outside and/or inside the secure area 12.

Control of the security system 10 may be accomplished via one or more processors 22, 24. The processors 22, 24 may be implemented as hardware that, in turn, are programmed to operate under control of one or more computer programs (applications) 26, 28 loaded from a non-transitory computer readable medium (memory) 20.

Under the illustrated embodiment, a number of security applications or programs 26, 28 may be installed within the control panel 14 and operate under control of a security level access processor 26, 28 located within a central monitoring station 36. Under the illustrated embodiment, an owner or other person authorized to administer to the security needs of the area 12 may subscribe to security services based upon the exigent needs of the environment in which the security system 10 is used.

For example, the person owning a home that defines the secure area 12 may subscribe to a minimum level of services from the central monitoring station 36. Minimum service may include intrusion detection based upon a set of sensors 16, 18 located along a perimeter of the home on doors and windows of the home.

In the case of minimum service, a user interface may be located near a front door of the home. The person may enter a pin number and activate an arm function key when he/she leaves and the PIN number and disarm function when he/she returns.

In the arm state, an alarm processor 22, 24 may monitor the sensors 16, 18 for intruders. In the event that a sensor is activated in the armed state, the alarm processor 22, 24 may activate a local alarm and compose and send an alarm message to the central monitoring station 36. In response, the central monitoring station 36 may summon the local police department to investigate.

On the other hand, the person administering the area 12 may subscribe to a second level of service that includes motion detection by a motion detection processor 22, 24 and sensors 16, 18 within certain select areas inside the area and camera surveillance of entry points via sensors 16, 18. The second level of service may also include the recording of video images into memory 20 upon detection of motion in the select areas by the motion detection processor. A presentation processor 22, 24 associated with the second level of service may be used by the homeowner to later view the recorded images.

Another third level of service may include video surveillance of all areas of a home by the motion detection processor 22, 24 and sensors 16, 18. The third level of service may be useful when the homeowner is on vacation.

Under the third level of service, video from the sensors 16, 18 may be saved by the motion detection processor 22, 24 into memory upon the detection of motion or continuously. An alarm processor 22, 24 that detects motion may send an alarm message to the central monitoring station 36 along with video associated with the event.

Another fourth level of service may include tracking of a mobile device 34 using a global positioning sensor (GPS) 38. In this case, the mobile device 34 may be an automobile with a navigation service (e.g., ONSTAR) where tracking of the mobile device 34 is provide through the navigation service. This fourth level of service may be useful to a homeowner on vacation who doesn't take their automobile or to a parent concerned with the whereabouts of their children. In this case, the tracked locations of the mobile device 34 may be viewed on the display 30 in real time or via the display of a map with various locations displayed along with a time that the mobile device 34 was at each location.

In general, each of the levels of service is provided through a respective set of security applications 26, 28 operating on the programmed processors 22, 24 of the security system 10. Under the illustrated embodiment, the person administering the area is able to subscribe to (and use) any one or more of the security applications 26, 28 in real time through a control interface provided through the user interface of the control panel 14.

Under one embodiment, access to the various levels of service may be controlled by an access processor 22, 24 located within the central monitoring station 36. In this case, the access processor 22, 24 tracks the level of service selected by person and bills the person for security services accordingly.

In this case, a control interface processor 22, 24 presents a control interface to the user including a menu of the various levels of service through the user interface of the panel 14. The user selects the level of service required and the control interface processor 22, 24 sends a service level request to the access processor 22, 24 within the central monitoring station 36. If the person making the request is in good standing, the access processor returns an authorization to the control interface processor 22, 24. The control interface processor 22, 24 responds by activating the selected security applications 26, 28 identified within the authorization.

In general, the sensors 16, 18 associated with each level of service are pre-installed within the secure area 12 and/or the assets (e.g., the automobile) 34 of the person. The security applications 26, 28 associated with each of the levels of service may also be installed in the control panel 14 and saved in memory 20.

Alternatively, the security applications 26, 28 may be saved in a corresponding memory 20 of the central monitoring station 36 and downloaded upon request. In this case, a preexisting configuration file located within memory 20 of the control panel 14 allows downloaded files to be automatically installed and activated based upon receipt of authorization for use of the downloaded security application 26, 28.

Under another illustrated embodiment, the security level access processor 22, 24 is located within the control panel 14. In this case, the access processor 22, 24 of the control panel 14 operates independently of the central monitoring station 36 and operates to simply inform the central monitoring station of the level of service selected. In response, the central monitoring station 36 provides support service as appropriate and bills for the level of service selected, but only for the period that the selected level of service is used.

Under another illustrated embodiment, the control interface may be accessible through a website hosted by a website processor 22, 24 operating on the central monitoring station. In this case, the person administering the area 12 may be able to access the control interface from a remote location to select a level of service appropriate for the circumstances. This may be important in the case of a homeowner going on vacation and later receiving reports of burglary in the locale of the secure area 12.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
establishing a plurality of security applications for an individual person, each embodied as a set of program steps saved in a non-transitory computer readable medium accessible by a security system of the person and each incorporating a respective set of sensors at least some of which provide intrusion detection for a secure geographical area of the person;
incorporating the plurality of security applications into a control interface of the person;
the control interface receiving one or more control instructions from the person, the received control instructions associated with at least one of the plurality of security applications; and
the at least one security application providing the security feature to the person based upon the input of the respective set of sensors in accordance with the set of control instructions.

2. The method as in claim 1 further comprising the person entering the one or more instructions through a user interface of a home security system.

3. The method as in claim 2 further comprising the at least one security application executing on a processor of the home security system.

4. The method as in claim 3 wherein the security feature further comprises detecting motion in an area secured by the home security system.

5. The method as in claim 1 further comprising the person entering the one or more instructions through a website of a central monitoring station.

6. The method as in claim 1 wherein the security feature further comprises detecting a location of an asset of the person.

7. The method as in claim 6 wherein the detecting of the location further comprises receiving a location from a global positioning system device carried by the asset.

8. A system comprising:
a plurality of security applications that each protect the physical assets or security of a person, each of the plurality of security applications embodied as a set of program steps in a respective non-transitory computer readable medium of the person, each incorporating a respective set of sensors and each providing a respective security feature for the direct benefit of the person;
a control interface incorporating the plurality of security applications of the person;
a programmed processor coupled to the control interface that receives one or more control instructions from the person, the received control instructions associated with at least one of the plurality of security applications;
a programmed processor that receives authorization to activate the at least one security application from a central monitoring station that operates to monitor a home security system of the person and that contacts a local fire or police department in the event of an emergency; and
a programmed processor that executes the at least one security application providing the security feature to the person based upon the received authorization and the input of the respective set of sensors in accordance with the set of control instructions.

9. The system as in claim 8 wherein the control interface further comprising a user interface of a home security system.

10. The system as in claim 8 wherein the control interface further comprises a website of a central monitoring station of a home security network.

11. The system as in claim 8 wherein one or more of the programmed processors further comprise a programmed processor of a home security system.

12. The system as in claim 8 wherein at least one of the sensors further comprises a motion detector.

13. The system as in claim 8 wherein the motion detector further comprises a television camera.

14. The system as in claim 8 wherein at least one of the sensors further comprises a global positioning sensor attached to an asset of the person.

15. A system comprising:
a plurality of security applications that each protect the physical assets or security of a person, each of the plurality of security applications embodied as a set of program steps saved in a respective non-transitory computer readable medium of a security system of the person and each incorporating a respective set of sensors at least some of which provide intrusion detection for a secure geographical area of the person;
a control interface incorporating the plurality of security applications of the person;
a programmed processor coupled to the control interface that receives one or more control instructions from the person, the received control instructions identifying at least one of the plurality of security applications;
a programmed processor that requests and receives authorization to activate the identified at least one security application from a remotely located central monitoring station that operates to monitor the home security system of the person and that contacts a local fire or police department in event of an emergency; and
a programmed processor that executes the at least one security application providing the security feature to the person based upon the received authorization and the input of the respective set of sensors in accordance with the set of control instructions.

16. The system as in claim 15 wherein at least one of the plurality of applications further comprises a camera system that monitors the secure area of the person.

17. The system as in claim 16 further comprising a programmed processor that detects motion in images produced by the camera system.

18. The system as in claim 15 wherein at least one of the plurality of applications further comprises a global positioning system that tracks a position of an asset of the person.

19. The system as in claim 18 further comprising at least one of the plurality of security applications that saves the tracked location into a file and that presents a record of the tracked location through a display of the security system.

20. The system as in claim 15 further comprising a mobile wireless device that presents the control interface to the person.
